(19) United States
(12) Patent Application Publication
(10) Pub. No.: US 2024/0205009 A1
(43) Pub. Date: Jun. 20, 2024

(54) ZERO-KNOWLEDGE PROOF AND EDGE COMPUTING-BASED BLOCKCHAIN AS A SERVICE (BAAS) SYSTEM AND METHOD TO IMPROVE DATA PRIVACY VULNERABILITIES

(71) Applicant: Pusan National University Industry-University Cooperation Foundation, Busan (KR)

(72) Inventors: Ho-won Kim, Busan (KR); Yohan Kim, Busan (KR); SANGBONG OH, Busan (KR); Kyeongwoo Oh, Busan (KR)

(21) Appl. No.: 18/487,130

(22) Filed: Oct. 16, 2023

(30) Foreign Application Priority Data
Dec. 16, 2022 (KR) 10-2022-0177346

(51) Int. Cl. H04L 9/32; H04L 9/00; H04L 9/08

(52) U.S. Cl. CPC H04L 9/3218; H04L 9/0877; H04L 9/50

(57) ABSTRACT

Disclosed are a zero-knowledge proof and edge computing-based blockchain as a service (BaaS) system and method to improve data privacy vulnerabilities. The data privacy enhancing BaaS system includes an edge node configured to store blockchain data in a blockchain built therein, and a cloud connected to the edge node and configured to provide management of a connection state of the edge node and a cloud service, wherein the blockchain may verify the blockchain data by applying zero-knowledge proof technology.

### CROSS-REFERENCE TO RELATED APPLICATION

This application claims the benefit of Korean Patent Application No. 10-2022-0177346, filed on Dec. 16, 2022, in the Korean Intellectual Property Office, the entire disclosure of which is incorporated herein by reference for all purposes.

### BACKGROUND

### 1. Field of the Invention

The present disclosure relates to a zero-knowledge proof and edge computing-based blockchain as a service (BaaS) system and method to improve data privacy vulnerabilities, that may provide a service-type blockchain model for solving data dependency and internal security issues such as leakage of sensitive information such as a wallet address, which are flaws of a blockchain in terms of security.

### 2. Description of the Related Art

Blockchain as a service (BaaS), an existing cloud-based blockchain providing service, alleviated the complexity and difficulties in deploying and managing blockchain systems and helped developers focus on business logic implementation.

BaaS has enabled companies to introduce blockchain systems more conveniently than before, but there were issues in that complete trust in a cloud service provider is needed since blockchain data is stored in the service provider, and that there might be a threat to privacy accordingly.

Edge computing technology for solving these privacy issues has tried to achieve privacy protection by storing blockchain data in an on-premise environment. However, edge computing has a security issue in that it is still vulnerable to internal malicious users.

Robust blockchain as a service (RBaaS) is a model extended to the edge computing environment to solve the privacy invasion issue of the existing cloud-based BaaS platform.

In RBaaS, blockchain data is stored in each EdgeZone connected to a cloud through a tunnel, and the cloud manages the EdgeZone. By doing this, RBaaS protected sensitive information from external third parties by localizing blockchain data used to be stored in existing cloud service providers.

However, blockchain data stored in an EdgeZone built in an on-premise environment allowed internal users to check the contents in the block. This could be problematic if sensitive business information is stored in a block.

Kaleido, a global company operating a BaaS platform, tried to solve the internal privacy invasion issue that occurs in RBaaS by applying zero-knowledge proof technology to a blockchain stored in a cloud. However, since data is still stored in the cloud, a data dependency issue, the issue of the existing BaaS, occurs. Due to this issue, Kaleido has an issue in the reliability of service providers.

Therefore, when sensitive information needs to be used in a blockchain, the introduction of an improved model designed to internally protect data while eliminating data dependency on BaaS service providers is desperately required.

### SUMMARY

Embodiments of the present disclosure are intended to provide a zero-knowledge proof and edge computing-based BaaS system and method to improve data privacy vulnerabilities, that may solve data dependency and internal security of sensitive information, which are flaws of a blockchain in terms of security, considering the risk that the existing cloud-based BaaS has poor security due to data dependency and internal malicious users.

In addition, embodiments of the present disclosure are intended to store sensitive data by resolving a data dependency issue without relying on cloud service providers by applying edge computing technology and to protect data from internal malicious users by internally applying zero-knowledge proof technology to a blockchain.

According to an aspect, there is provided a zero-knowledge proof and edge computing-based blockchain as a service (BaaS) system to improve data privacy vulnerabilities, the BaaS system including an edge node configured to store blockchain data in a blockchain built therein; and a cloud connected to the edge node and configured to provide management of a connection state of the edge node and a cloud service, wherein the blockchain may verify the blockchain data by applying zero-knowledge proof technology.

At this time, an internal node of the blockchain may include at least a trusted third party (TTP), a user (prover), and a verifier node, wherein, in the applying of the zero-knowledge proof technology, the blockchain may be further configured to generate a proving key (PK) and a verification key (VK), transmit the PK to the user, and transmit the VK to the verifier node, by the TTP, generate a proof using the blockchain data and the PK, by the user (prover), and verify validity of the proof using the VK, by the verifier node.

At this time, the cloud may include an edge node manager configured to connect the edge node; a cloud control plane configured to synchronize with the edge node connected to the cloud; and a cloud network manager configured to manage communication with the edge node.

At this time, the edge node manager may be further configured to register the edge node and connect the edge node to the cloud according to a connection request from the registered edge node, the cloud control plane may be further configured to synchronize with the edge node connected to the cloud, and the cloud network manager may be further configured to monitor the connection state between the cloud and the edge node through the cloud control plane.

At this time, when the connection state is determined to be “disconnection” by the monitoring, the cloud network manager may be further configured to generate a repair request including a repair plan by analyzing a cause related to “disconnection”, and the edge node manager may be further configured to reconnect the edge node to the cloud according to the repair plan, in response to the repair request.

According to an aspect, there is provided a zero-knowledge proof and edge computing-based BaaS method to improve data privacy vulnerabilities, the BaaS method including storing, by an edge node, blockchain data in a blockchain built therein; and providing, by a cloud connected to the edge node, management of a connection state of the edge node and a cloud service, wherein the blockchain may verify the blockchain data by applying zero-knowledge proof technology.

At this time, the BaaS method may further include, in the applying of the zero-knowledge proof technology, generating, by a TTP of the blockchain, a PK and a VK, transmitting the PK to the user, and transmitting the VK to the verifier node; generating, by a user (prover) of the blockchain, a proof using the blockchain data and the PK; and verifying, by a verifier node of the blockchain, validity of the proof using the VK.

At this time, the BaaS method may further include connecting, by an edge node manager of the cloud, the edge node; synchronizing, by a cloud control plane of the cloud, with the edge node connected to the cloud; and managing, by a cloud network manager of the cloud, communication with the edge node.

At this time, the BaaS method may further include registering, by the edge node manager, the edge node and connecting the edge node and the cloud according to a connection request from the registered edge node; synchronizing, by the cloud control plane, with the edge node connected to the cloud; and monitoring, by the could network manager, a connection state between the cloud and the edge node through the cloud control plane.

At this time, the BaaS method may further include, when the connection state is determined to be “disconnection” by the monitoring, generating, by the cloud network manager, a repair request including a repair plan by analyzing a cause related to “disconnection”; and reconnecting, by the edge node manager, the edge node to the cloud according to the repair plan, in response to the repair request.

According to an aspect, there is provided a zero-knowledge proof and edge computing-based BaaS system to improve data privacy vulnerabilities, the BaaS system including an edge node configured to store blockchain data in a blockchain built therein; and a cloud including an edge node manager configured to connect the edge node, a cloud control plane configured to synchronize with the connected edge node, and a cloud network manager configured to manage communication with the edge node, wherein the cloud may be configured to provide management of a connection state of the edge node and a cloud service, wherein the edge node manager may be further configured to register the edge node and connect the edge node to the cloud according to a connection request from the registered edge node, the cloud control plane may be further configured to synchronize with the edge node connected to the cloud, and the cloud network manager may be further configured to monitor the connection state between the cloud and the edge node through the cloud control plane, wherein the blockchain may be configured to verify the blockchain data by applying zero-knowledge proof technology.

According to an aspect, there is provided a zero-knowledge proof and edge computing-based BaaS method to improve data privacy vulnerabilities, the BaaS method including storing, by an edge node, blockchain data in a blockchain built therein; connecting, by an edge node manager of a cloud, the edge node, wherein the connecting may include registering the edge node, and connecting the edge node and the cloud according to a connection request from the registered edge node; synchronizing, by a cloud control plane of the cloud, with the connected edge node, wherein the synchronizing may include synchronizing with the edge node connected to the cloud; managing, by a cloud network manager of the cloud, communication with the edge node, wherein the managing may include monitoring a connection state between the cloud and the edge node through the cloud control plane; and providing, by the cloud connected with the edge node, management of the connection state of the edge node and a cloud service, wherein the blockchain may be further configured to verify the blockchain data by applying zero-knowledge proof technology.

Additional aspects of embodiments will be set forth in part in the description which follows and, in part, will be apparent from the description, or may be learned by practice of the disclosure.

According to an embodiment of the present disclosure, it is possible to provide a zero-knowledge proof and edge computing-based BaaS system and method to improve data privacy vulnerabilities, that may solve data dependency and internal security of sensitive information, which are flaws of a blockchain in terms of security, considering the risk that the existing cloud-based BaaS has poor security due to data dependency and internal malicious users.

In addition, according to the present disclosure, it is possible to store sensitive data by resolving a data dependency issue without relying on cloud service providers by applying edge computing technology and to protect data from internal malicious users by internally applying zero-knowledge proof technology to a blockchain.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a zero-knowledge proof and edge computing-based blockchain as a service (BaaS) system to improve data privacy vulnerabilities according to an embodiment of the present disclosure;

FIG. 2 is a diagram illustrating a configuration of a model for implementing a data privacy enhancing edge computing-based blockchain as a service (EBaaS) system of the present disclosure;

FIG. 3 is a diagram illustrating a zero-knowledge proof operation procedure according to the present disclosure;

FIG. 4 is a diagram illustrating an edge node synchronizing and monitoring operation according to the present disclosure;

FIG. 5 is a diagram illustrating a repairing operation when an edge node is disconnected according to the present disclosure;

FIG. 6 is a diagram illustrating a structure of edge computing; and

FIG. 7 is a flowchart illustrating a zero-knowledge proof and edge computing-based BaaS method to improve data privacy vulnerabilities according to an embodiment of the present disclosure.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

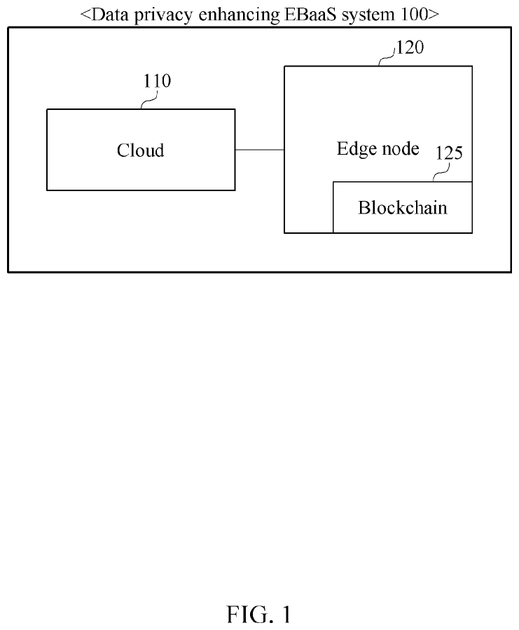

FIG. 1 is a block diagram illustrating a configuration of a zero-knowledge proof and edge computing-based blockchain as a service (BaaS) system to improve data privacy vulnerabilities according to an embodiment of the present disclosure.

Referring to FIG. 1, a zero-knowledge proof and edge computing-based BaaS system (hereinafter, abbreviated as the “data privacy enhancing edge computing-based blockchain as a service (EBaaS) system”) 100 to improve data privacy vulnerabilities according to an embodiment of the present disclosure may include a cloud 110 and an edge node 120. The edge node 120 may include a blockchain 125 to which zero-knowledge proof technology is applied.

The edge node 120 stores blockchain data in the blockchain 125 built therein. That is, the edge node 120 may apply edge computing technology to store blockchain data that is autonomously operated and managed in the internal blockchain 125, thereby resolving a data dependency issue. At this time, the edge node 120 may apply edge computing technology through a processor (not shown). Further, the edge node 120 may include a memory (not shown) for storing the blockchain 125.

In particular, the blockchain 125 may verify the blockchain data by applying zero-knowledge proof technology.

A zero-knowledge proof refers to a method by which one party proves to the counterparty that corresponding information is owned by him/her without providing any information to the counterparty. The zero-knowledge proof technology applied to the blockchain 125 enables a privacy protection function that does not reveal data and anonymization of transactions that allows parties to exchange transaction information without verifying each other's identity.

More specifically, an internal node of the blockchain 125 may include at least a trusted third party (TTP), a user (prover), and a verifier node.

In the application of zero-knowledge proof technology, the blockchain 125 may generate a proving key (PK) and a verification key (VK), transmit the PK to the user, and transmit the VK to the verifier node, by the TTP.

Then, the user (prover) may generate a proof using the blockchain data and the PK.

In addition, the verifier node may verify the validity of the proof using the VK, thereby enhancing blockchain data privacy based on a zero-knowledge proof.

The cloud 110 is connected to the edge node 120 and provides management of a connection state of the edge node 120 and a cloud service.

The cloud 110 may include an edge node manager, a cloud control plane, and a cloud network manager. In this case, the edge node manager, the cloud control plane, and the cloud network manager may be included in a processor (not shown) of the cloud 110 or may be configured separately.

The edge node manager may connect a predetermined edge node to be connected to the cloud and manage the edge node.

The cloud control plane may perform synchronization with an edge node connected to the cloud 110 to copy a connection state between the cloud 110 and the edge node.

The cloud network manager may manage communication with the edge node connected to the cloud 110.

In an embodiment in which the cloud 110 and the edge node 120 are connected to synchronize, the edge node manager may register the edge node 120, and connect the edge node 120 to the cloud 110 according to a connection request from the registered edge node 120. In addition, the cloud control plane may synchronize with the edge node 120 connected to the cloud 110.

Thereafter, the cloud network manager may monitor the connection state between the cloud 110 and the edge node 120 through the cloud control plane synchronizing with the edge node 120.

In addition, in an embodiment in which the connection of the edge node 120, disconnected from the cloud 110 due to an unexpected network failure, to the cloud 110 is restored, the cloud network manager may generate a repair request including a repair plan by analyzing a cause related to “disconnection” when the connection state is determined to be “disconnection” by the monitoring.

In addition, the edge node manager may reconnect the edge node to the cloud according to the repair plan, in response to the repair request.

After the edge node 120 is reconnected to the cloud 110, the data privacy enhancing BaaS system 100 of the present disclosure may perform the synchronization procedure described above and monitor the connection state between the cloud 110 and the edge node 120.

According to an embodiment of the present disclosure, it is possible to provide a zero-knowledge proof and edge computing-based BaaS system and method to improve data privacy vulnerabilities, that may solve data dependency and internal security of sensitive information, which are flaws of a blockchain in terms of security, considering the risk that the existing cloud-based BaaS has poor security due to data dependency and internal malicious users.

In addition, according to the present disclosure, it is possible to store sensitive data by resolving a data dependency issue without relying on cloud service providers by applying edge computing technology and to protect data from internal malicious users by internally applying zero-knowledge proof technology to a blockchain.

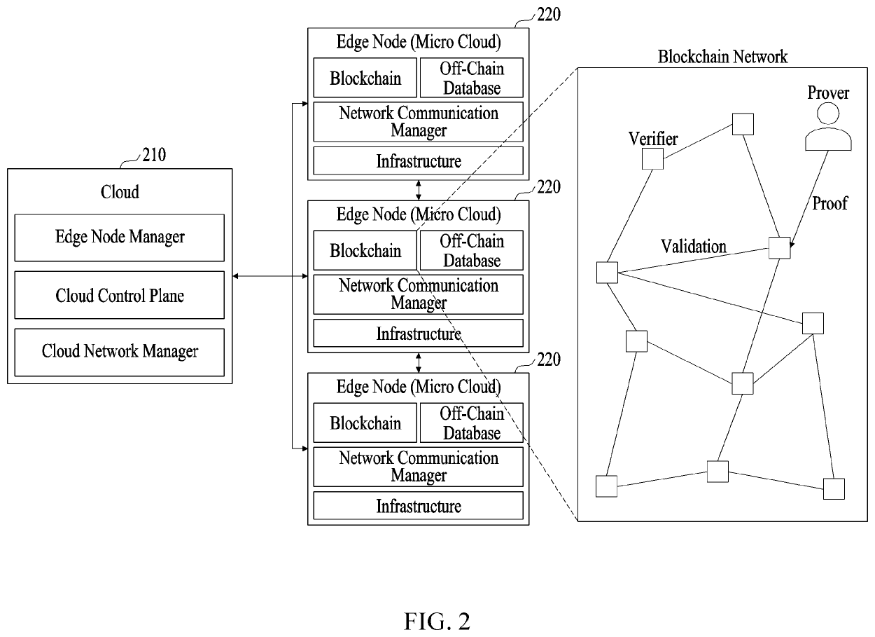

FIG. 2 is a diagram illustrating a configuration of a model for implementing a data privacy enhancing EBaaS system of the present disclosure.

As shown in FIG. 2, a blockchain providing service related to the data privacy enhancing EBaaS system 100 is configured in a form in which a cloud is located at the top and a plurality of edge nodes 220 are connected to the cloud 210.

The cloud 210 includes an edge node manager for managing the connected edge nodes 220, a cloud control plane for managing and adjusting the entire environment, and a cloud network manager for managing communication between nodes.

Each edge node 220 includes an infrastructure, a blockchain, an off-chain database, and a network communication manager.

Since a blockchain is built in an edge node 220, blockchain data is stored in the edge node 220, not in the cloud 210, and zero-knowledge proof technology is applied to the blockchain.

The operation procedure of the data privacy enhancing EBaaS system 100 will be described in terms of privacy protection for external/internal subjects.

The data privacy enhancing EBaaS system 100 stores blockchain data in an edge node 220 built in an on-premise environment, not in the cloud 210, and thus, may protect sensitive data without a user's relying on cloud service providers (external entities).

The data privacy enhancing EBaaS system 100 applied zero-knowledge proof technology to the blockchain built in the edge node 220, and thus, may allow a verifier to verify data in the block even when the data is unknown.

The data privacy enhancing EBaaS system 100 may solve the existing issue of vulnerable security for internal entities even in an on-premise environment through this structure.

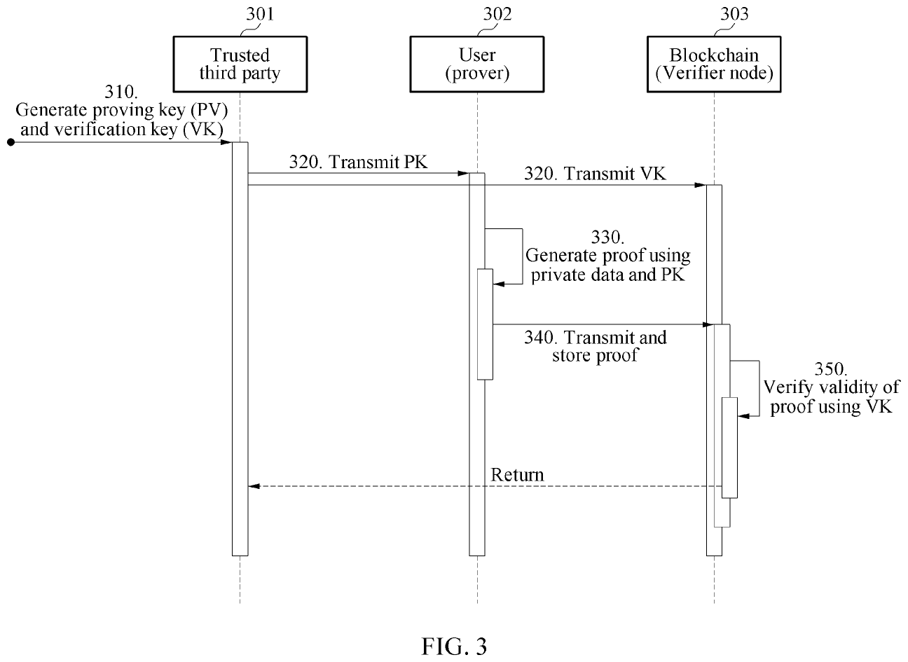

FIG. 3 is a diagram illustrating a zero-knowledge proof operation procedure according to the present disclosure.

Zero-knowledge proof technology is applied to a blockchain of an edge node.

A zero-knowledge proof may perform a function to protect user information privacy when a user wants to store sensitive information in a blockchain.

Hereinafter, with reference to FIG. 3, operations of a zero-knowledge proof protocol will be described step by step.

In operation 310, a reliable TTP 301 may generate a PK and a VK.

In operation 320, the TTP 301 may transmit the PK to a user (prover) 302 and the VK to a verifier node of a blockchain 303.

In operation 330, the user (prover) 302 may generate a proof using sensitive information (private data) to be stored in the blockchain 303 and the PK received from the TTP 301.

In operation 340, the user (prover) 302 may transmit the generated proof and store the proof in the blockchain 303.

In operation 350, the verifier node of the blockchain 303 may verify the validity of the proof transmitted by the user using the VK received from the TTP.

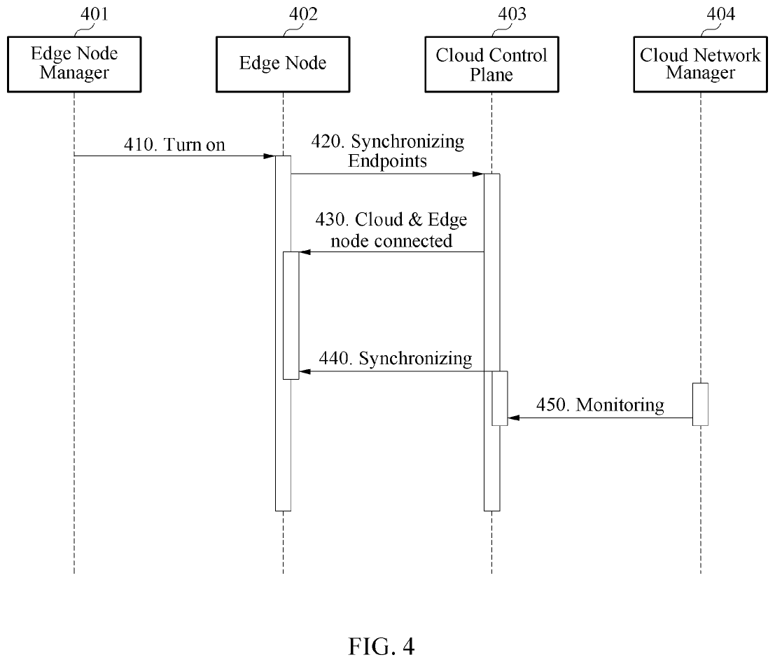

FIG. 4 is a diagram illustrating an edge node synchronizing and monitoring operation according to the present disclosure.

A cloud network manager 404 of a cloud may continuously monitor the connection between a cloud control plane 403 and an edge node 402 and synchronize service endpoint information.

Hereinafter, an edge node synchronizing and monitoring operation will be described step by step with reference to FIG. 4.

In operation 410, an edge node Manager 401 registers an edge node to be connected to a cloud (Turn on).

In operation 420, the edge node 402 requests connection from the cloud control plane 403 (Synchronizing Endpoints).

In operation 430, the cloud control plane 403 accepts the request from the edge node and, accordingly, connects to the edge node (Cloud & Edge node connected).

In operation 440, the cloud control plane 403 synchronizes the connection state of the edge node connected to the cloud (Synchronizing).

In operation 450, the cloud network manager 404 may monitor the connection state of the edge node through the cloud control plane 403.

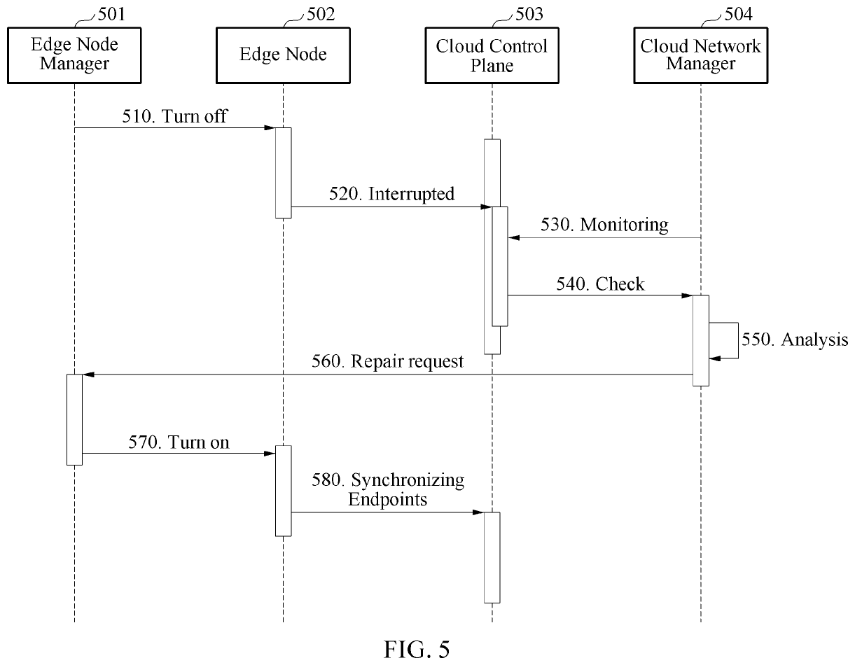

FIG. 5 is a diagram illustrating a repairing operation when an edge node is disconnected according to the present disclosure.

If the connection between a cloud and an edge node is interrupted, a cloud network manager 504 may repair a network of a predetermined edge node according to a different predetermined service set in a configuration and a state.

Hereinafter, with reference to FIG. 5, an operation of repair when an edge node is disconnected will be described step by step.

In operation 510, as an edge node is disconnected from a cloud, the edge node manager 504 unregisters the disconnected edge node (Turn off).

In operation 520, a cloud control plane 503 detects that the edge node is disconnected (Interrupted).

In operation 530, the cloud network manager 504 monitors that the edge node is disconnected (Monitoring).

In operation 540, the cloud control plane 503 verifies that the edge node is disconnected (Check).

In operation 550, the cloud network manager 504 searches for a repair plan by analyzing a state and configuration settings (Analysis).

In operation 560, the cloud network manager 504 requests the edge node Manager 501 to repair (Repair request).

In operation 570, the edge node manager 501 repairs the connection with the edge node according to the request (Turn on).

In operation 580, the edge node is reconnected to the cloud, and the cloud control plane 503 performs a task of synchronizing the connection state (Synchronizing Endpoints).

BaaS is a cloud service that allows a blockchain to be easily built and used by combining the disadvantage that a blockchain is difficult to use with a cloud having flexible resource management and excellent accessibility.

BaaS has greatly increased the accessibility to blockchains and is being used in various domains.

However, BaaS is a cloud-based service and thus, still has security issues, which are the issues of a cloud service.

The present disclosure proposes EBaaS, a new BaaS model that may provide security by applying zero-knowledge proof (ZKP) and edge computing technology to BaaS.

EBaaS may remove data dependency on a cloud by applying edge computing technology, provide high availability of blockchains, and provide security for internally sensitive data by utilizing ZKP.

Blockchain technology, which is rapidly developing as a key technology of the next industrial revolution, has properties of immutability, traceability, anonymity, and transparency and thus, is used in various fields, and many companies are considering introducing blockchain technology.

With an increasing interest in blockchain technology, BaaS has emerged as a new service that enables a blockchain system to be built and managed easily and conveniently without professional knowledge.

BaaS is a cloud-based blockchain providing service that alleviates the complexity and difficulties in deploying and managing blockchain systems and helps developers focus on business logic implementation.

With the advent of BaaS, companies have been able to introduce blockchain systems more conveniently than before. However, BaaS has the disadvantages in that complete trust in a cloud service provider is needed since blockchain data is stored in the service provider, and that there might be a threat to privacy accordingly.

In order to solve this issue, in recent years, research for achieving privacy protection by storing blockchain data in an on-premise environment by applying edge computing technology has been conducted.

However, a BaaS service using edge computing technology may achieve the purpose of protecting privacy from outsiders, but have an issue in that security against internal malicious users is weak.

The present disclosure proposes EBaaS, a new model that stores blockchain data in an on-premise environment by applying edge computing technology to the existing cloud-based BaaS system and improves the security of the stored blockchain data using a zero-knowledge proof.

EBaaS may achieve the purpose of protecting privacy from outsiders through edge computing technology and the purpose of protecting data from internal malicious users through zero-knowledge proof.

According to the present disclosure, companies considering introducing blockchains in the future may easily and conveniently build and manage blockchain systems without concern of privacy invasion.

BaaS refers to conveniently providing a high-performance blockchain ecosystem and related services to developers using the advantages of deployment and management of cloud service infrastructures, by building a blockchain framework in a cloud computing platform.

The developers may quickly build blockchain networks through such basic cloud services and support applications while ignoring the complexity of basic architectures.

Thus far, many global companies such as IBM, Microsoft, and Amazon have launched BaaS platforms and achieved good results.

However, as described above, the existing BaaS platforms store blockchain data in cloud service providers and thus, still have issues to be addressed in terms of privacy protection.

Edge computing refers to a technology for computing downstream data instead of a cloud service and upstream data instead of an IoT service at the edge of a network.

The edge refers to a location at which computing is processed between data sources and a cloud data center. For example, a smartphone may be an edge between a body and a cloud, and a gateway of a smart home may be an edge between a home and a cloud.

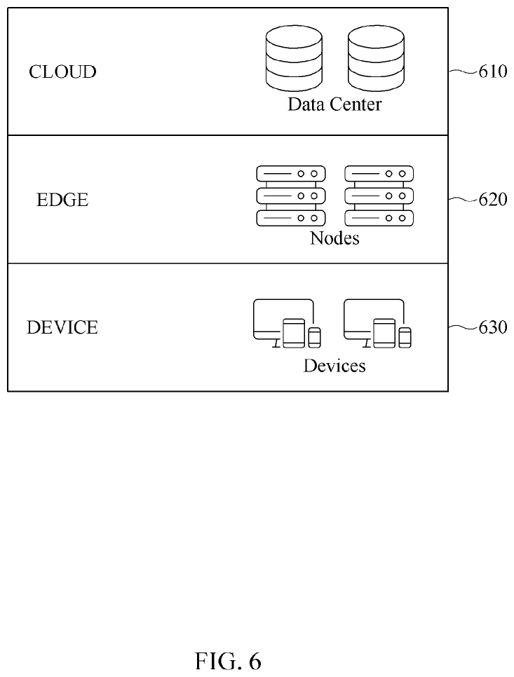

FIG. 6 is a diagram illustrating a structure of edge computing.

A cloud 610 includes a data center.

Nodes of an edge 620 perform actual data processing, analysis, and computing.

Edge computing performs data processing near a device 630 in which data sources are stored and thus, has the advantages of less latency, less runtime, and less response time compared to cloud computing.

A zero-knowledge proof is an interactive protocol between a prover P and a verifier V.

The operation method of the zero-knowledge proof is as follows.

When the prover P and the verifier V have a computation problem x, and only P knows the solution w of x, a zero-knowledge proof allows P to prove to V the fact that P knows the solution w to the problem x, without providing any information related to w.

In other words, the zero-knowledge proof is a system for proving that one knows the information without disclosing the information the one knows.

A zero-knowledge proof must satisfy the following three properties.

1. Completeness: If the prover P knows w, the verifier V must be convinced of this fact by the prover P.

2. Soundness: If a prover PP does not know w, the prover P can never prove to the verifier V that the prover P knows w.

3. Zero-knowledge: During the verification process, the verifier V can not figure out any additional information about w.

The present disclosure proposes a new model that combines edge computing technology and zero-knowledge proof technology to solve the privacy protection issues of the existing cloud-based BaaS platforms.

According to the present disclosure, companies or societies considering introducing blockchains in the future may quickly and conveniently build blockchain systems and may store and manage sensitive information more safely through a security level higher than before in terms of data protection.

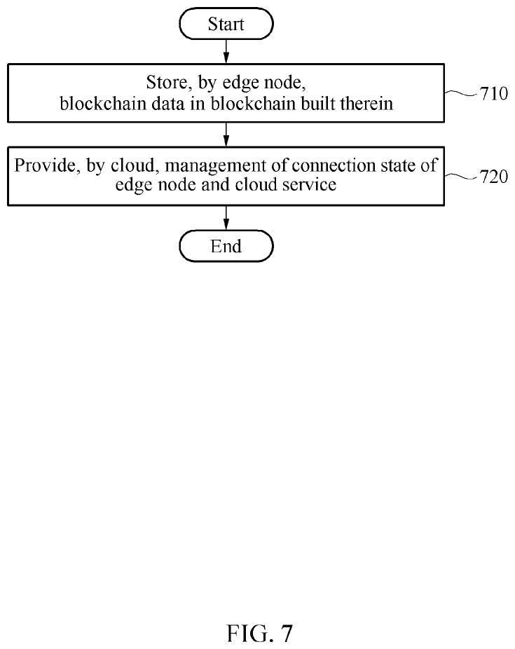

Hereinafter, a flow of implementation of the data privacy enhancing BaaS system 100 according to embodiments of the present disclosure will be described in detail with reference to FIG. 7.

FIG. 7 is a flowchart illustrating a zero-knowledge proof and edge computing-based BaaS method to improve data privacy vulnerabilities according to an embodiment of the present disclosure.

The zero-knowledge proof and edge computing-based BaaS method to improve data privacy vulnerabilities according to the present embodiment may be performed by the data privacy enhancing EBaaS system 100.

First, in operation 710, an edge node of the data privacy enhancing EBaaS system 100 stores blockchain data in a blockchain built therein. Operation 710 may be performed by a processor of the edge node.

Operation 710 may be a process of applying, by the edge node, edge computing technology to store blockchain data that is autonomously operated and managed in an internal blockchain, thereby resolving a data dependency issue.

In particular, the blockchain may verify the blockchain data by applying zero-knowledge proof technology.

A zero-knowledge proof refers to a method by which one party proves to the counterparty that corresponding information is owned by him/her without providing any information to the counterparty. The zero-knowledge proof technology applied to the blockchain enables a privacy protection function that does not reveal data and anonymization of transactions that allows parties to exchange transaction information without verifying each other's identity.

More specifically, an internal node of the blockchain may include at least a TTP, a user (prover), and a verifier node.

In the application of zero-knowledge proof technology, the blockchain may generate a PK and a VK, transmit the PK to the user, and transmit the VK to the verifier node, by the TTP.

Then, the user (prover) may generate a proof using the blockchain data and the PK.

In addition, the verifier node may verify the validity of the proof using the VK, thereby enhancing blockchain data privacy based on a zero-knowledge proof.

In operation 720, the cloud of the data privacy enhancing EBaaS system 100 provides management of a connection state of the edge node and a cloud service. Operation 720 may be performed by a processor of the cloud.

The cloud may include an edge node manager, a cloud control plane, and a cloud network manager.

The edge node manager may connect a predetermined edge node to be connected to the cloud and manage the edge node.

The cloud control plane may perform synchronization with an edge node connected to the cloud to copy a connection state between the cloud and the edge node.

The cloud network manager may manage communication with the edge node connected to the cloud.

In an embodiment in which the cloud and the edge node are connected to synchronize, the edge node manager may register the edge node, and connect the edge node to the cloud according to a connection request from the registered edge node.

In addition, the cloud control plane may synchronize with the edge node connected to the cloud.

Thereafter, the cloud network manager may monitor the connection state between the cloud and the edge node through the cloud control plane synchronizing with the edge node.

In addition, in an embodiment in which the connection of the edge node, disconnected from the cloud due to an unexpected network failure, to the cloud is restored, the cloud network manager may generate a repair request including a repair plan by analyzing a cause related to “disconnection” when the connection state is determined to be “disconnection” by the monitoring.

In addition, the edge node manager may reconnect the edge node to the cloud according to the repair plan, in response to the repair request.

After the edge node is reconnected to the cloud, the data privacy enhancing Baas system of the present disclosure may perform the synchronization procedure described above and monitor the connection state between the cloud and the edge node.

According to an embodiment of the present disclosure, it is possible to provide a zero-knowledge proof and edge computing-based BaaS system and method to improve data privacy vulnerabilities, that may solve data dependency and internal security of sensitive information, which are flaws of a blockchain in terms of security, considering the risk that the existing cloud-based BaaS has poor security due to data dependency and internal malicious users.

In addition, according to the present disclosure, it is possible to store sensitive data by resolving a data dependency issue without relying on cloud service providers by applying edge computing technology and to protect data from internal malicious users by internally applying zero-knowledge proof technology to a blockchain.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example examples, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents. Therefore, other implementations, other examples, and equivalents to the claims are also within the scope of the following claims.

1. A zero-knowledge proof and edge computing-based blockchain as a service (BaaS) system to improve data privacy vulnerabilities, the BaaS system comprising:
an edge node configured to store blockchain data in a blockchain built therein; and
a cloud comprising an edge node manager configured to connect the edge node, a cloud control plane executed in the cloud and configured to synchronize with the connected edge node, and a cloud network manager executed in the cloud and configured to manage communication with the edge node, wherein the cloud is configured to provide management of a connection state of the edge node and a cloud service, wherein the edge node manager, the cloud control plane, and the cloud network manager are distinctly executed by at least one processor in the cloud;
wherein the edge node manager is further configured to register the edge node and connect the edge node to the cloud according to a connection request from the registered edge node,
the cloud control plane executed in the cloud is further configured to synchronize with the edge node connected to the cloud, and
the cloud network manager is further configured to monitor the connection state between the cloud and the edge node through the cloud control plane,
wherein the blockchain is configured to verify the blockchain data by applying zero-knowledge proof technology.

2. The BaaS system of claim 1, wherein an internal node of the blockchain comprises at least a trusted third party (TTP), a user (prover), and a verifier node,
wherein, in the applying of the zero-knowledge proof technology,
the blockchain is further configured to:
generate a proving key (PK) and a verification key (VK), transmit the PK to the user, and transmit the VK to the verifier node, by the TTP,
generate a proof using the blockchain data and the PK, by the user (prover), and
verify validity of the proof using the VK, by the verifier node.

3. The BaaS system of claim 1, wherein
when the connection state is determined to be “disconnection” by the monitoring,
the cloud network manager is further configured to generate a repair request comprising a repair plan by analyzing a cause related to “disconnection”, and
the edge node manager is further configured to reconnect the edge node to the cloud according to the repair plan, in response to the repair request.

4. A zero-knowledge proof and edge computing-based blockchain as a service (BaaS) method to improve data privacy vulnerabilities, the BaaS method comprising:
storing, by an edge node, blockchain data in a blockchain built therein;
connecting, by an edge node manager of and executed in a cloud, the edge node, wherein the connecting comprises registering the edge node, and connecting the edge node and the cloud according to a connection request from the registered edge node;
synchronizing, by a cloud control plane of and executed in the cloud, with the connected edge node, wherein the synchronizing comprises synchronizing with the edge node connected to the cloud;
managing, by a cloud network manager of and executed in the cloud, communication with the edge node, wherein the managing comprises monitoring a connection state between the cloud and the edge node through the cloud control plane, wherein the edge node manager, the cloud control plane, and the cloud network manager are distinctly executed by at least one processor in the cloud; and
providing, by the cloud connected with the edge node, management of the connection state of the edge node and a cloud service,
wherein the blockchain is further configured to verify the blockchain data by applying zero-knowledge proof technology.

5. The BaaS method of claim 4, wherein an internal node of the blockchain comprises at least a trusted third party (TTP), a user (prover), and a verifier node,
wherein the BaaS method further comprises:
in the applying of the zero-knowledge proof technology,
generating, by a trusted third party (TTP) of the blockchain, a proving key (PK) and a verification key (VK), transmitting the PK to the user, and transmitting the VK to the verifier node,
generating, by a user (prover) of the blockchain, a proof using the blockchain data and the PK; and
verifying, by a verifier node of the blockchain, validity of the proof using the VK.

6. The BaaS method of claim 4, wherein the BaaS method further comprises:
when the connection state is determined to be “disconnection” by the monitoring,
generating, by the cloud network manager, a repair request comprising a repair plan by analyzing a cause related to “disconnection”; and
reconnecting, by the edge node manager, the edge node to the cloud according to the repair plan, in response to the repair request.

7. The BaaS system of claim 1, wherein when the connection state is determined to be disconnected:
the edge node manager unregisters the edge node that is disconnected;
the cloud control plane verifies that the edge node is disconnected;
the cloud network manager searches for a repair by analyzing settings;
the cloud network manager repairs the connection state according to a different predetermined service set in a configuration and state; and
the cloud control plane synchronizes the connection state of the edge node and the cloud.
